(19) United States
(12) Patent Application Publication
(10) Pub. No.: US 2016/0180409 A1
(43) Pub. Date: Jun. 23, 2016

(54) METHOD AND SYSTEM FOR ONLINE ADVERTISING BASED ON DYNAMIC ADVERTISEMENT PLACEMENT

(71) Applicant: Videology Inc., Baltimore, MD (US)

(72) Inventor: Akshay H. Shah, San Jose, CA (US)

(21) Appl. No.: 14/576,287

(22) Filed: Dec. 19, 2014

(51) Int. Cl. G06Q 30/02

(52) U.S. Cl. CPC G06Q 30/0277; G06Q 30/0269

(57) ABSTRACT

The present teaching relates to online advertising based on dynamic advertisement placement. In one example, a request for providing an advertisement to a user is received. A request for an advertisement to be presented to a user is received. The request is received with information associated with a plurality of advertisement placements. Information related to the user is obtained. From the plurality of advertisement placements, at least one advertisement placement is selected based, at least in part, on the information related to the user. Each of one or more parties is requested to provide a response with respect to the selected at least one advertisement placement. At least one response is associated with an advertisement to be presented to the user. Information associated with the advertisement is transmitted in response to the request.

### BACKGROUND

1. Technical Field

The present teaching relates to methods and systems for online advertising. Specifically, the present teaching relates to methods and systems for online advertisement placement.

2. Discussion of Technical Background

Online advertising involves the technologies and services for selecting and placing advertisements on websites. Advertisement serving entities provide services to website hosts, online content providers and/or advertisers to serve advertisements, including choosing the advertisements that will enhance the revenue associated with the advertisements and/or monitor the effectiveness of different advertising campaigns. Advertisement servers may be divided into two types: publisher advertisement servers (publishers) and advertiser (or third party) advertisement servers (advertisers). In a modern online advertisement exchange network, additional intermediary parties may be involved in the advertisement serving process, including supply-side platforms (SSPs), which enable publishers to manage their advertising impression inventory and maximize revenue from digital media, and demand-side platforms (DSPs), which allow advertisers to purchase advertising impressions across a range of publishers. Publishers make their advertisement impressions available through advertisement placements (also known as “marketplaces”) by SSPs, and DSPs automatically decide which of those advertisement impressions it makes the most sense for an advertiser to purchase.

An advertisement placement is a specific group of advertisement units or spaces on which an advertiser can choose to place their advertisements on a publisher's website. An advertisement placement may be as broad as an entire website or as specific as a single advertisement unit or space on one webpage. FIG. 1 (prior art) depicts an exemplary static advertisement placement configuration. In this example, a publisher creates multiple advertisement placements (e.g., #101, #201, . . . #n01), each of which is in an operating mode (e.g., real-time bidding (RTB), passback, guaranteed, etc.). In FIG. 1, each advertisement placement created by the publisher has to be associated with a different tag via a unique endpoint URL. For instance, a RTB tag with its accompanying URL #1 is uniquely associated with advertisement placement #101, while another passback tag with a different URL #2 has to be created for advertisement placement #201. This type of static advertisement placement configuration causes various problems: first, a publisher has to spend a considerable amount of time on putting different tags and URLs all over its website and managing the different tags and URLs. In particular, with a new advertisement placement, the publisher has to put a new tag and URL on the website. This makes the jobs of creating and managing advertisement placements tedious and inefficient.

Also, the static advertisement placement configuration as shown in FIG. 1 causes loss of potential revenue for the publisher, for instance, when there is no winner in the RTB mode. The static advertisement placement configuration also causes loss of network resources, if the publisher decides to call a different tag, e.g., a guaranteed tag, when the RTB tag did not yield a favorable response. FIG. 2 (prior art) is a time-line chart of an exemplary static advertisement placement execution process in the RTB mode. By activating the RTB tag on the publisher's website or application, a user browser 202 makes a request for executing the advertisement placement 101 (a static advertisement placement call) to the SSP 204. The advertisement placement 101 has been set up by the publisher as in the RTB mode with a floor price of $10 cost-per-thousand impressions (CPM). The SSP 204 then solicits responses from various DSPs 206-1, 206-2, . . . , 206-n, respectively, with respect to the advertisement placement 101 based on the criteria set by the publisher. If no DSP is interested in bidding the advertisement placement 101 or the bid does not meet the criteria, this would cause loss of revenue on that advertisement placement call. At that time, the publisher may have to serve a default advertisement (e.g., the publisher's own advertisement) or leave the advertisement space blank. FIG. 3 (prior art) is a time-line chart of an exemplary static advertisement placement execution process in the passback mode. Similarly, if the designated DSP 206 is not interested in the advertisement placement 201 (set up by the publisher as in the passback mode at $8 CPM), this would cause loss of revenue on that advertisement placement call as well. At that time, the publisher may have to serve a default advertisement or leave the advertisement space blank.

Therefore, there is a need to provide a solution for a more efficient and effective approach for creating and managing advertisement placements to avoid the above-mentioned drawbacks.

### SUMMARY

The present teaching relates to methods and systems for online advertising. Specifically, the present teaching relates to methods and systems for online advertisement placement.

In one example, a method, implemented on at least one computing device each having at least one processor, storage, and a communication platform connected to a network for providing an advertisement is presented. A request for an advertisement to be presented to a user is received. The request is received with information associated with a plurality of advertisement placements. Information related to the user is obtained. From the plurality of advertisement placements, at least one advertisement placement is selected based, at least in part, on the information related to the user. Each of one or more parties is requested to provide a response with respect to the selected at least one advertisement placement. At least one response is associated with an advertisement to be presented to the user. Information associated with the advertisement is transmitted in response to the request.

In another example, a method, implemented on at least one computing device each having at least one processor, storage, and a communication platform connected to a network for providing content to a user is presented. A first request is received from a user for content. First information indicative of at least one advertisement unit to be provided with the content is obtained. A second request is sent for second information related to at least one advertisement to be presented to the user on the at least one advertisement unit. The request is sent with third information associated with a plurality of advertisement placements with respect to the at least one advertisement unit. At least one advertisement placement is selected from the plurality of advertisement placements based, at least in part, on fourth information related to the user. Each of one or more parties is requested to provide a response with respect to the selected at least one advertisement placement. At least one response is associated with the at least one advertisement to be presented to the user. The second information identified in response to the request is then received. The content is provided with the at least one advertisement to the user.

In still another example, a method, implemented on at least one computing device each having at least one processor, storage, and a communication platform connected to a network for providing a tag for multiple advertisement placements is presented. A party is facilitated to create a plurality of advertisement placements with respect to a website or an application. The party is facilitated to provide one or more parameters for each of the plurality of advertisement placements. A tag to be placed on the website or the application is provided to the party. The tag is associated with the plurality of advertisement placements. At least one of the one or more parameters is associated with information related to a user that is to be dynamically obtained upon receiving a request including the tag for an advertisement to be presented to the user on the website or the application.

In a different example, a system having at least one processor, storage, and a communication platform for presenting an advertisement is presented. The system includes a request handling unit, an information monitoring unit, an advertisement placement decision unit, an advertisement placement solicitation unit, and a transmission unit. The request handling unit is configured to a request for an advertisement to be presented to a user. The request is received with information associated with a plurality of advertisement placements. The information monitoring unit is configured to obtain information related to the user. The advertisement placement decision unit is configured to select, from the plurality of advertisement placements, at least one advertisement placement based, at least in part, on the information related to the user. The advertisement placement solicitation unit is configured to request each of one or more parties to provide a response with respect to the selected at least one advertisement placement. At least one response is associated with an advertisement to be presented to the user. The transmission unit is configured to transmit information associated with the advertisement in response to the request.

In another example, a system having at least one processor, storage, and a communication platform for providing a tag for multiple advertisement placements is presented. The system includes an advertisement placements creation unit, an advertisement placements configuration unit, and a tag generation unit. The advertisement placements creation unit is configured to facilitate a party to create a plurality of advertisement placements with respect to a website or an application. The advertisement placements configuration unit is configured to facilitate the party to provide one or more parameters for each of the plurality of advertisement placements. The tag generation unit is configured to provide, to the party, a tag to be placed on the website or the application. The tag is associated with the plurality of advertisement placements. At least one of the one or more parameters is associated with information related to a user that is to be dynamically obtained upon receiving a request including the tag for an advertisement to be presented to the user on the website or the application.

Other concepts relate to software for implementing the present teaching on online advertising based on dynamic advertisement placement. A software product, in accord with this concept, includes at least one non-transitory machine-readable medium and information carried by the medium. The information carried by the medium may be executable program code data, parameters in association with the executable program code, and/or information related to a user, a request, content, or information related to a social group, etc.

In one example, a non-transitory machine readable medium having information recorded thereon for presenting an advertisement is presented. A request for providing an advertisement to a user is received. A request for an advertisement to be presented to a user is received. The request is received with information associated with a plurality of advertisement placements. Information related to the user is obtained. From the plurality of advertisement placements, at least one advertisement placement is selected based, at least in part, on the information related to the user. Each of one or more parties is requested to provide a response with respect to the selected at least one advertisement placement. At least one response is associated with an advertisement to be presented to the user. Information associated with the advertisement is transmitted in response to the request.

In another example, a non-transitory machine readable medium having information recorded thereon for providing content to a user is presented. A first request is received from a user for content. First information indicative of at least one advertisement unit to be provided with the content is obtained. A second request is sent for second information related to at least one advertisement to be presented to the user on the at least one advertisement unit. The request is sent with third information associated with a plurality of advertisement placements with respect to the at least one advertisement unit. At least one advertisement placement is selected from the plurality of advertisement placements based, at least in part, on fourth information related to the user. Each of one or more parties is requested to provide a response with respect to the selected at least one advertisement placement. At least one response is associated with the at least one advertisement to be presented to the user. The second information identified in response to the request is then received. The content is provided with the at least one advertisement to the user.

In still another example, a non-transitory machine readable medium having information recorded thereon for providing a tag for multiple advertisement placements is presented. A party is facilitated to create a plurality of advertisement placements with respect to a website or an application. The party is facilitated to provide one or more parameters for each of the plurality of advertisement placements. A tag to be placed on the website or the application is provided to the party. The tag is associated with the plurality of advertisement placements. At least one of the one or more parameters is associated with information related to a user that is to be dynamically obtained upon receiving a request including the tag for an advertisement to be presented to the user on the website or the application.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 (prior art) depicts an exemplary static advertisement placement configuration;

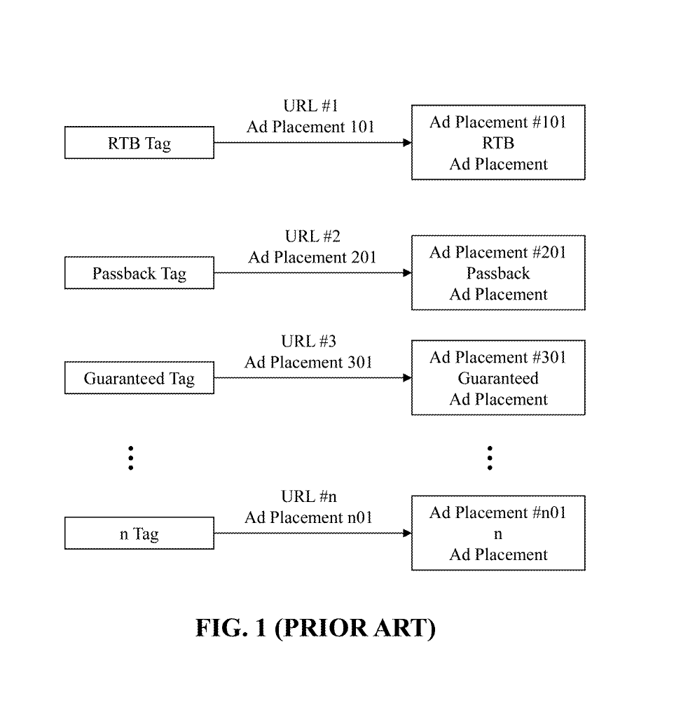

FIG. 2 (prior art) is a time-line chart of an exemplary static advertisement placement execution process in the RTB mode;

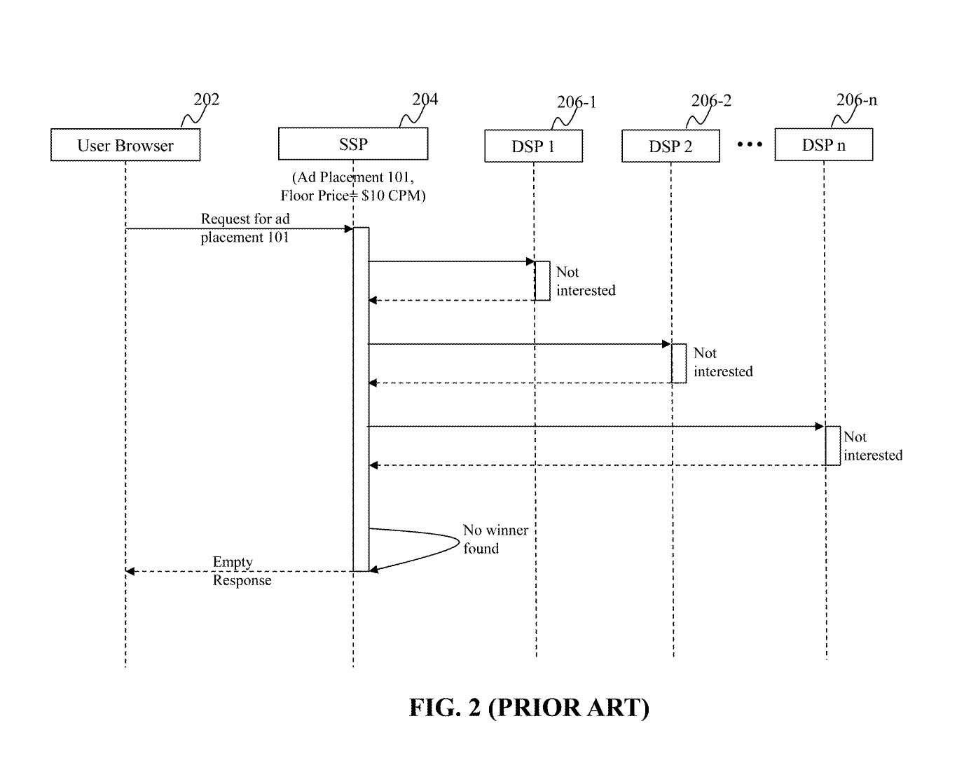

FIG. 3 (prior art) is a time-line chart of an exemplary static advertisement placement execution process in the passback mode;

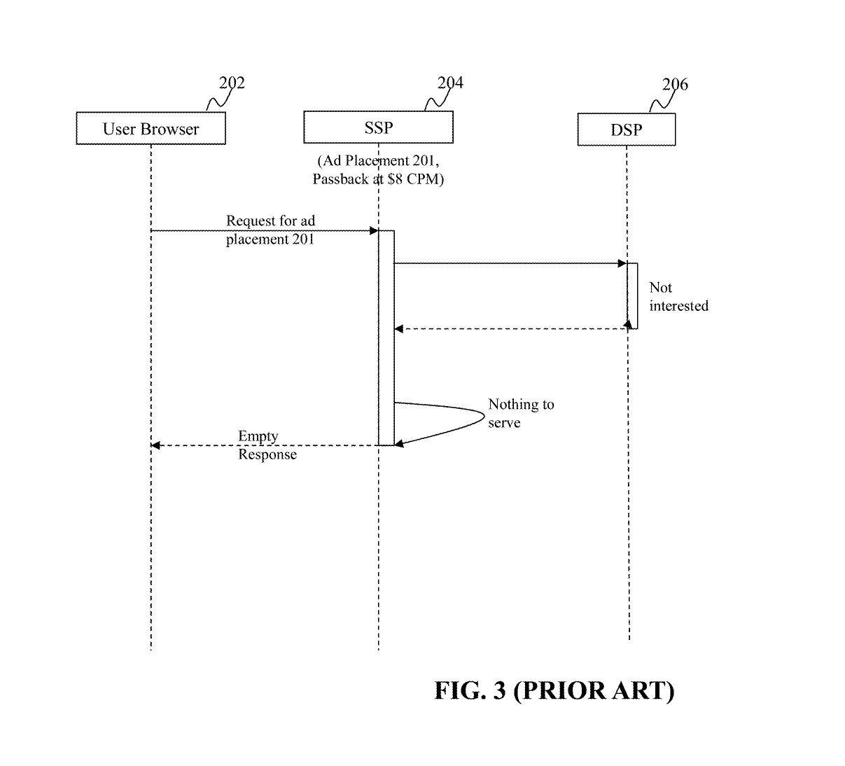

FIG. 4 depicts an exemplary dynamic advertisement placement configuration with a single smart tag, according to an embodiment of the present teaching;

FIG. 5 is an exemplary illustration of dynamic determination of advertisement placements and the execution sequence thereof, according to an embodiment of the present teaching;

FIG. 6 is a high level exemplary system diagram of an advertisement exchange network in which the present teaching can be applied, according to an embodiment of the present teaching;

FIG. 7 is an exemplary illustration of dynamic execution of advertisement placements, according to an embodiment of the present teaching;

FIG. 8 is an exemplary system diagram of an advertisement placement system shown in FIG. 6, according to an embodiment of the present teaching;

FIG. 9 is a flowchart of an exemplary process for facilitating publishers to set up multiple advertisement placements associated with a single tag, according to an embodiment of the present teaching;

FIG. 10 illustrates one example of a user interface for multiple advertisement placements setup, according to an embodiment of the present teaching;

FIG. 11 illustrates another example of a user interface for multiple advertisement placements setup, according to an embodiment of the present teaching;

FIG. 12 illustrates still another example of a user interface for multiple advertisement placements setup, according to an embodiment of the present teaching;

FIG. 13 is a flowchart of an exemplary process for selecting advertisement based on dynamic advertisement placement, according to an embodiment of the present teaching;

FIG. 14 is a flowchart of another exemplary process for selecting advertisement based on dynamic advertisement placement, according to an embodiment of the present teaching;

FIG. 15 is a flowchart of exemplary processes for dynamically determining advertisement placement in various tag operating modes, according to various embodiments of the present teaching;

FIG. 16 is a time-line chart of an exemplary dynamic advertisement placement execution process, according to an embodiment of the present teaching;

FIG. 17 depicts the architecture of a mobile device which can be used to implement a specialized system incorporating the present teaching; and

FIG. 18 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teaching may be practiced without such details. In other instances, well known methods, procedures, components, and/or circuitry have been described at a relatively high-level, without detail, in order to avoid unnecessarily obscuring aspects of the present teaching.

The present disclosure describes method, system, and programming aspects of efficient and effective online advertisement serving based on dynamic advertisement placement realized as a specialized and networked system by utilizing one or more computing devices (e.g., mobile phone, personal computer, etc.) and network communications (wired or wireless). The method and system as disclosed herein aim at simplifying the creation and management of multiple advertisement placements for a publisher by associating multiple advertisement placements with one single smart tag. The publisher's efforts of placing and managing multiple tags on its assets (website or application) are thus reduced. Moreover, the method and system as disclosed herein can determine the most suitable combination of advertisement placements and their execution sequence at runtime based on the dynamic situation when the advertisement serving request is received. The dynamic situation includes, for example, information related to a user who is visiting the publisher's website. The dynamically determined advertisement placements and their execution sequence can maximize the probability of generating revenue from the advertisement placements and can fully utilize network resources by targeting the advertisement placements to the potential purchasers (e.g., advertisers) and avoiding empty response.

Additional features will be set forth in part in the description which follows, and in part will become apparent to those skilled in the art upon examination of the following and the accompanying drawings or may be learned by production or operation of the examples. The features of the present teaching may be realized and attained by practice or use of various aspects of the methodologies, instrumentalities and combinations set forth in the detailed examples discussed below.

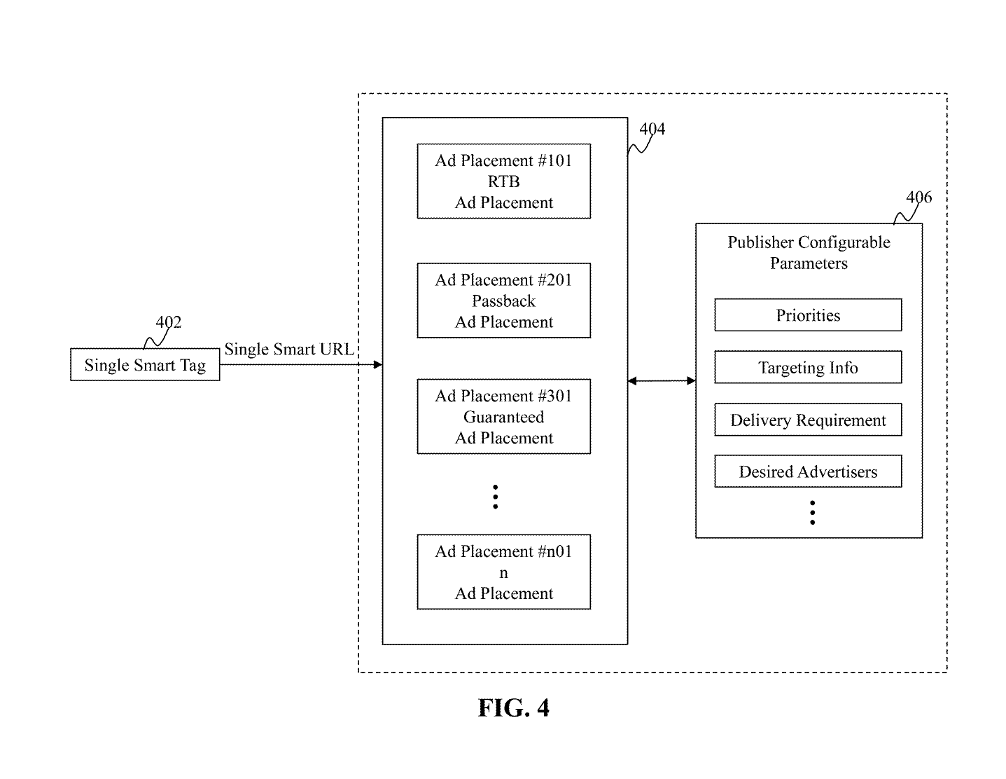

FIG. 4 depicts an exemplary dynamic advertisement placement configuration with a single smart tag, according to an embodiment of the present teaching. In this embodiment, a single “smart” tag 402 with a URL is associated with multiple advertisement placements 404. In the web environment, the single smart tag 402 may be an HTML element in one or more pages of a publisher's website, which includes a URL or any pointer that is associated with the specific combination of advertisement placements 404. In the application environment, the single smart tag 402 may be code embedded in the publisher's application, which includes a URL or any pointer that is associated with the specific combination of advertisement placements 404. Each advertisement placement 404 may be a specific group of advertisement units or spaces on which an advertiser can choose to place their advertisements on a publisher's website or application. An advertisement placement 404 may be as broad as an entire website of the publisher or as specific as a single advertisement unit or space on one webpage. Each advertisement placement 404 in this embodiment is configured by the publisher in a particular operating mode, including but not limited to, RTB mode, passback mode, guaranteed mode, etc.

The combination of advertisement placements 404 in this embodiment is associated with various configurable parameters 406 that can be set up by the publisher. The configurable parameters 406 include, for example, priorities for determining the execution order of the advertisement placements 404, targeting information of the potential audiences of the advertisement placements 404, delivery requirements such as an agreement that the publisher has entered into with one or more advertisers, and desired advertisers of the advertisement placements 404. It is understood that any other suitable parameters that are related to advertisement placement creation, management, or execution may be configured by the publisher as part of the configurable parameters 406.

As described below in detail, the configurable parameters 406 may be used to dynamically determine the actual combination of advertisement placement and execution order at runtime when the single smart 402 is activated with an advertisement serving request. That is, the tag 402 is “smart” in the sense that which suitable advertisement placement(s) from the initial set of advertisement placements 404 are sent to which advertisers in what order is dynamically determined in response to each advertisement serving request in order to achieve the goal of maximizing the potential revenue from a single advertisement serving request. Various factors may be considered when making the dynamic decision, including for example criteria, limitations, conditions, and goals set up by the publisher (owner of the advertisement placements) in the form of configurable parameters 406, information related to the users (audiences of advertisement), or information related to the advertisers (potential purchasers of the advertisement placements). It is also understood that because the multiple advertisement placements 404 and their configurable parameters 406 are associated with a single smart tag 402, only one network call needs to be made by the user from the publisher's webpage or application to the SSP to which the tag 402 is directed. The SSP then can dynamically determine the most suitable advertisement placement(s) to be executed and the execution order thereof. Even if the first one or several advertisement placements cannot be satisfied, the SSP in this embodiment does not return an empty response but instead, can automatically continue to try the next suitable advertisement placement in the execution order until a favorable response is received.

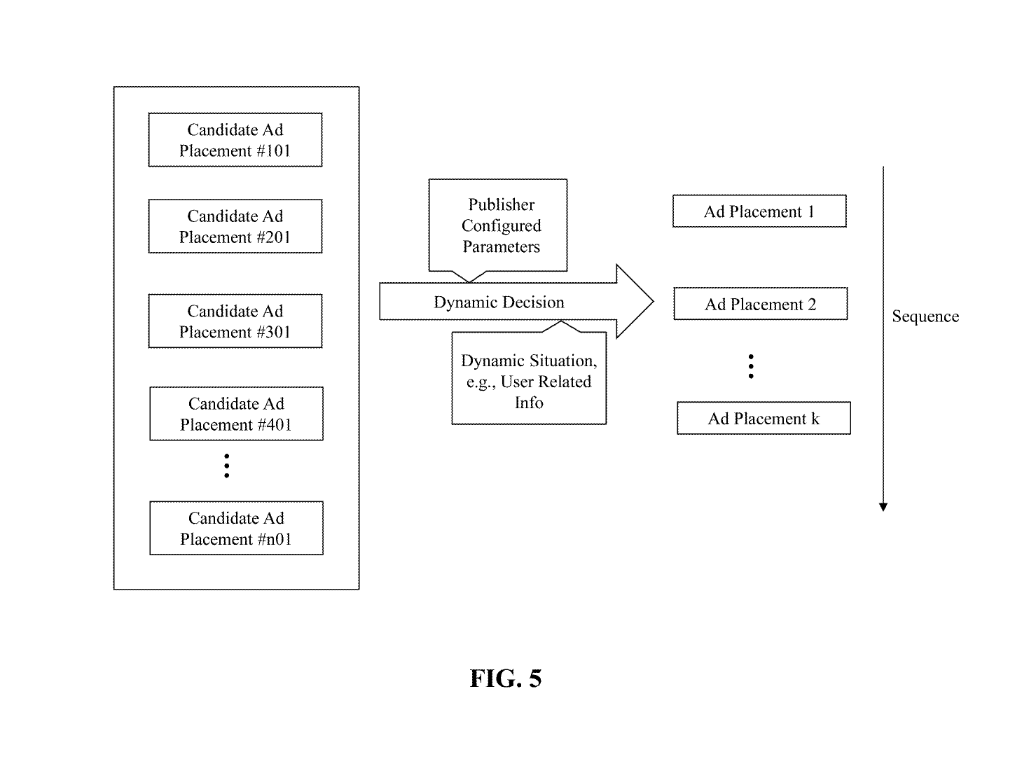

FIG. 5 is an exemplary illustration of dynamic determination of advertisement placements and the execution sequence thereof, according to an embodiment of the present teaching. As shown in FIG. 5, the initial set of candidate advertisement placements #101, #201, . . . , #n01 may be preset by a publisher. The publisher may decide the preferred order for executing some or all of the candidate advertisement placements. The publisher may create the candidate advertisement placements in an offline process in order to generate the single smart tag. At runtime, when the single smart tag is activated, for example, by a user visiting the publisher's webpage or opening the publisher's application in which the single smart tag is placed, a dynamic decision can be made as to which one or more advertisement placements from the candidate advertisement placements are to be executed in what order. The dynamic determination may be made based on the parameters pre-configured by the publisher when the single smart tag is created and based on dynamic situation such as user-related information. For instance, the publisher may specify that one of the advertisement placements is targeted to a particular demographic user group, e.g., female under the age of 20. On the other hands, if the user to which the advertisement serving request is directed fits the particular demographic user group, then that advertisement placement is most likely selected as a top advertisement placement to be executed. In addition to user-related information, the dynamic situation may include information related to advertisers.

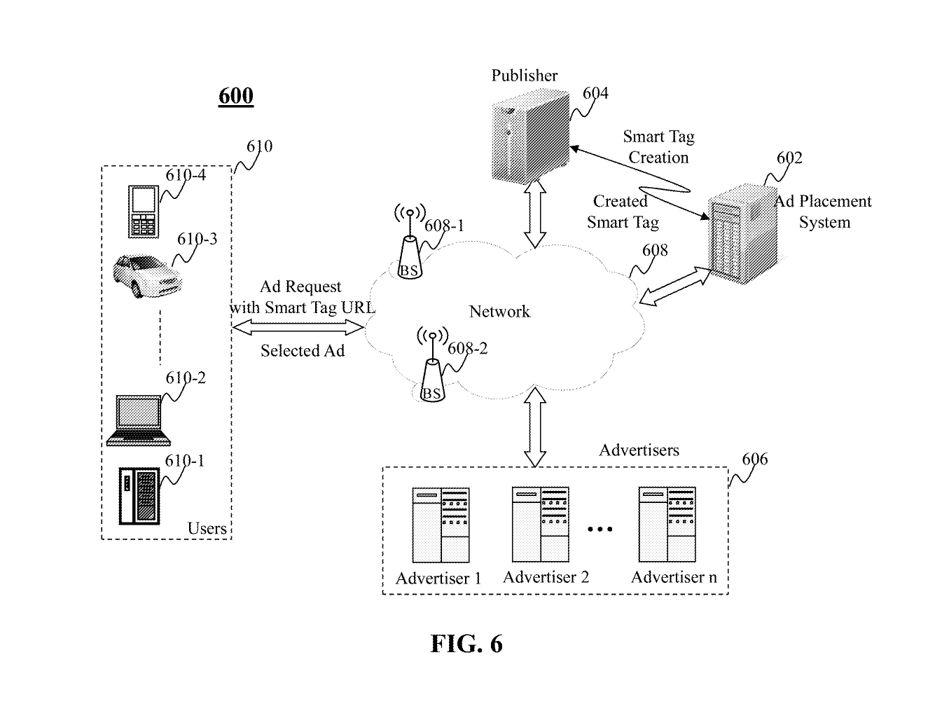

FIG. 6 is a high level exemplary system diagram of an advertisement exchange network in which the present teaching can be applied, according to an embodiment of the present teaching. In FIG. 6, the advertisement exchange network 600 includes an advertisement placement system 602, a publisher 604, one or more advertisers 606, a network 608, and users 610. The network 608 may be a single network or a combination of different networks. For example, the network 608 may be a local area network (LAN), a wide area network (WAN), a public network, a private network, a proprietary network, a Public Telephone Switched Network (PSTN), the Internet, a wireless network, a virtual network, or any combination thereof. The network 608 may also include various network access points, e.g., wired or wireless access points such as base stations or Internet exchange points 608-1, . . . , 608-2, through which a data source may connect to the network 608 in order to transmit information via the network 608.

In this embodiment, the publisher 604 may be any entity that hosts one or more advertisement spaces on its asset (e.g., website, or application). The advertisement spaces may be purchased, via advertisement placement, by advertisers to place their advertisements. The advertisements may be presented to the users 610 when the users 610 get access to the publisher 604's assets. The users 610 may be of different types such as users connected to the network 608 via desktop computers 610-1, laptop computers 610-2, a built-in device in a motor vehicle 610-3, or a mobile device 610-4. In this embodiment, the advertisement placement system 602 serves as an SSP or part of an SSP for the publisher 604. The publisher 604 may create, using the advertisement placement system 602, a smart tag associated with multiple advertisement placements and manage the advertisement placements by configuring parameters as described before. The created smart tag may be put onto the publisher 604's website or application, which can be visited by the users 610.

When a user 610 gets access to the publisher 604, the user 610's device may send an advertisement serving request with the smart tag URL via the network 608 to the advertisement placement system 602. By recognizing the smart tag and its associated initial set of advertisement placements and configured parameters, the advertisement placement system 602 in this embodiment dynamically determines at least one advertisement placement from the initial set and sends a serial of requests to the advertisers 606 to solicit responses with respect to the selected advertisement placement(s) in a certain order. In other words, the advertisement placement system 602, on behalf of the publisher 604, negotiates with the advertisers 606 to obtain the maximum potential revenue generated from the advertisement serving request with the single smart tag. Based on the responses from the advertisers 606, the advertisement placement system 602 selects an advertisement to be rendered on the user's device 610 at the corresponding advertisement unit/space hosted by the publisher 604.

In one use case, the publisher 604 receives a request from a user 610 for content on the publisher 604's website or application. The publisher 604 then obtains information indicative of the available advertisement unit(s) on the website or application to be provided with the content. As described above, the advertisement unit(s) have been associated with multiple advertisement placements via a smart tag for the publisher 604. The publisher 604 then sends an advertisement serving request to the advertisement placement system 602 for providing advertisement(s) on the available advertisement unit(s) to the user 610. The request is associated with the multiple initial advertisement placements. The advertisement placement system 602 then at runtime dynamically selects appropriate advertisement placement(s) and decide their execution order if more than one advertisement placement are selected. Based on the responses from advertisers 606 to the dynamically selected advertisement placement(s), at least one advertisement can be determined, and its information is returned to the publisher 604 by the advertisement placement system 602. Based on the received information, the publisher 604 may retrieve the at least one advertisement and placing them at the advertisement unit(s) so that they can be presented to the user 610 together with the requested content.

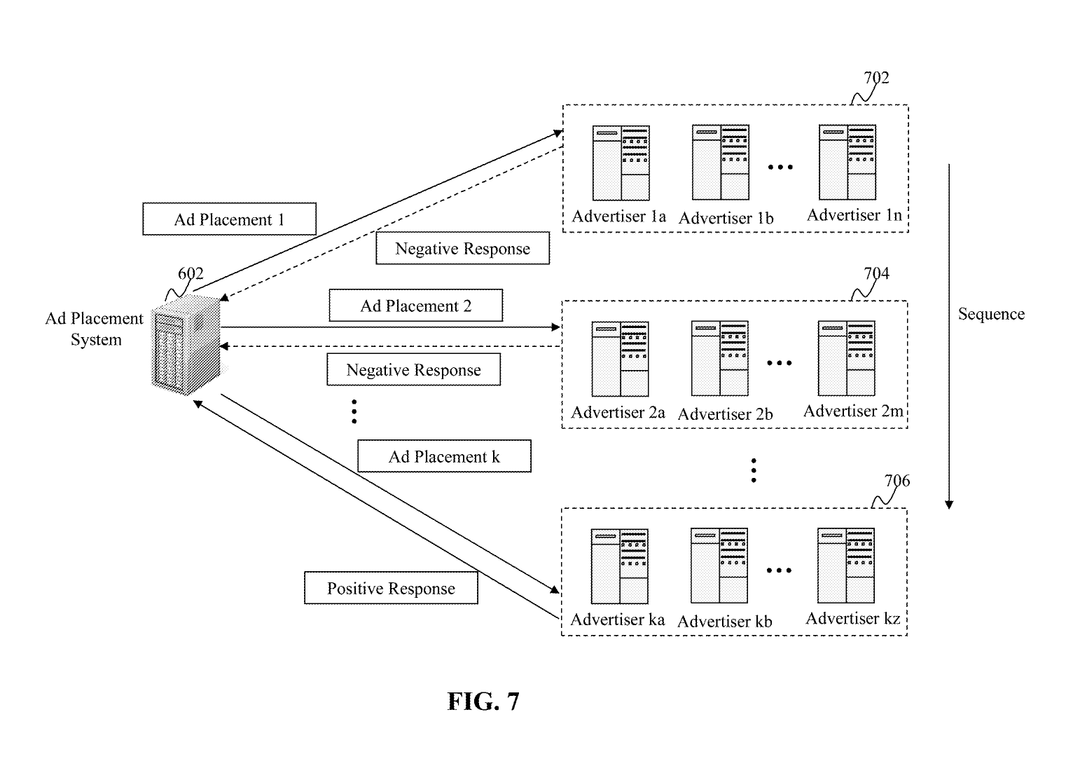

FIG. 7 is an exemplary illustration of dynamic execution of advertisement placements, according to an embodiment of the present teaching. It is noted that in the present disclosure, the term “advertiser” covers the DSPs of the advertiser as well. As described above, by recognizing a smart tag and its associated initial set of advertisement placements and configured parameters, the advertisement placement system 602 may dynamically determine suitable advertisement placement(s) from the initial set and the execution sequence thereof. In this embodiment, the advertisement placement system 602 decides to negotiate with a first set of advertisers 1a, 1b, . . . 1n 702 with respect to the first advertisement placement 1 (e.g., the top ranked one). The first set of advertisers 1a, 1b, . . . 1n 702 may also be dynamically determined by the advertisement placement system 602 based, at least in part, on the parameters configured by the publisher (e.g., preferred advertisers for each advertisement placement, delivery requirement for each advertisement placement, etc.) and information related to the advertisers. The advertisement placement system 602 in this embodiment sends a first request to the first set advertisers 1a, 1b, . . . 1n 702 to solicit responses with respect to the first advertisement placement 1. If a positive response is received from any of the advertisers in the first set 702, e.g., a winning bid in the RTB mode or an acceptance in the passback mode, then the advertisement placement associated with the single smart tag is satisfied, and the advertisement placement system 602 will not execute other advertisement placements 2-k. Otherwise, the advertisement placement system 602 continues to negotiate with a second set of advertisers 2a, 2b, . . . 2n 704 with respect to the second advertisement placement 2 (e.g., the second top ranked one). It is understood that as the second set of advertisers 2a, 2b, . . . 2n 704 are dynamically determined for the second advertisement placement 2, it may be different from the first set of advertisers 1a, 1b, . . . 1n 702. In this embodiment, the negotiation with the second set of advertisers 2a, 2b, . . . 2n 704 with respect to the second advertisement placement 2 is failed (a negative or empty response is received), so the process continues until the kth advertisement placement k is satisfied (a positive response is received from the kth set of advertisers ka, kb, . . . kn 706).

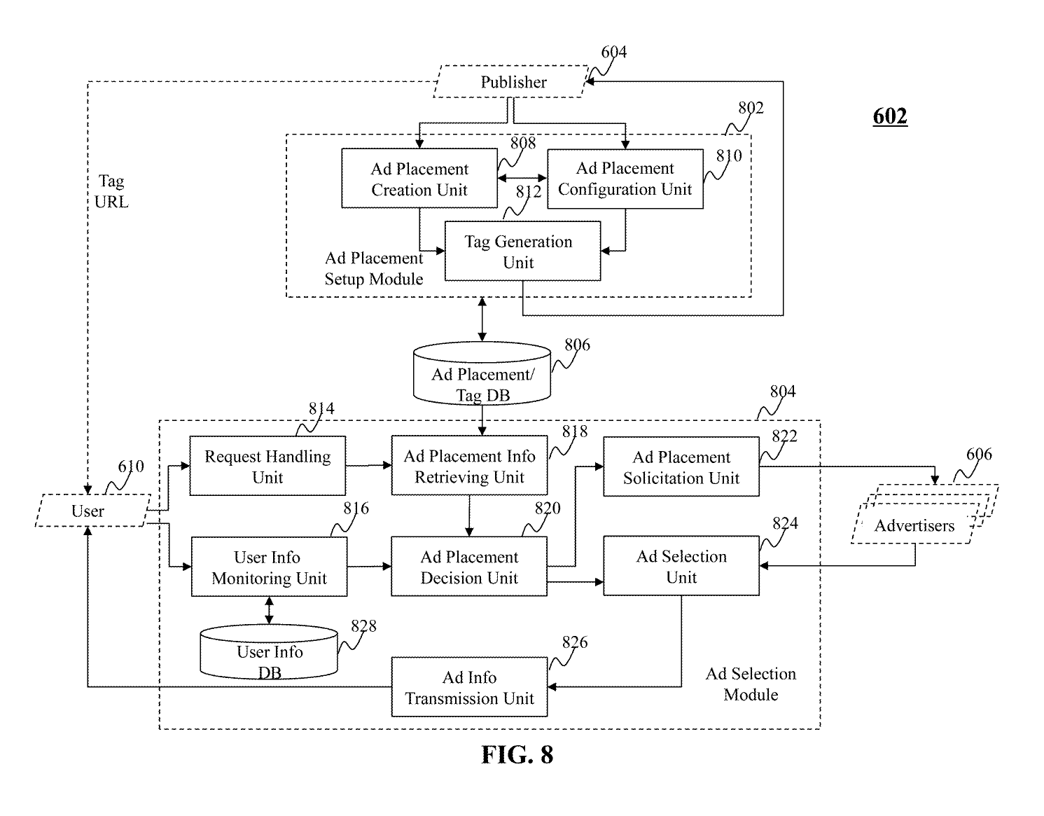

FIG. 8 is an exemplary system diagram of an advertisement placement system shown in FIG. 6, according to an embodiment of the present teaching. The advertisement placement system 602 includes an advertisement placement setup module 802, an advertisement selection module 804, and an advertisement placement/tag database 806. The advertisement placement setup module 802 in this embodiment facilitates a publisher 604 to create and manage its smart tag with associated multiple advertisement placements. The created smart tags and their associated advertisement placements and configured parameter are stored in the advertisement placement/tag database 806. The advertisement selection module 804 in this embodiment selects advertisement(s) provided by advertisers 606 in response to an advertisement serving request with a smart tag URL that can be recognized from all the smart tags stored in the advertisement placement/tag database 806.

In this embodiment, the advertisement placement setup module 802 includes an advertisement placement creation unit 808, an advertisement placement configuration unit 810, and a tag generation unit 812. The advertisement placement creation unit 808 is configured to facilitate a publisher 604 to create multiple advertisement placements with respect to the website of the publisher 604. In some embodiments, the advertisement placements may be created with respect to an application of the publisher 604. The advertisement placement configuration unit 810 is configured to facilitate the publisher 604 to provide configurable parameters for each advertisement placement. The parameter includes, for example, priority, targeted user profile, desired advertiser, delivery requirement of the corresponding advertisement placement, etc. Each type of parameter may be provided for some or all of the advertisement placements as needed. For example, the publisher 604 may specify a preferred execution order of the advertisement placements by assigning priorities to each advertisement placement. In another example, for any advertisement placement operated in the passback mode, a desired advertiser may be specified by the publisher 604. In still another example, the publisher 604 may configure the delivery requirement for each advertisement placement operated in the guaranteed mode and monitor the delivery status and statistics towards completing the guaranteed deal with an advertiser. It is understood that the publisher 604 may not only create the initial set of advertisement placements and set the initial values of the configurable parameters, but also manage and update the existing advertisement placements and values of the configurable parameter via the advertisement placement configuration unit 810 and the advertisement placement creation unit 808. For example, the publisher 604 may manually increase or decrease the initial floor price of an advertisement placement operated in the RTB mode as time goes by in view of the performance data of the advertisement placement (e.g., favorable response ratio).

The tag generation unit 812 in this embodiment is responsible for providing, to the publisher 604, a tag to be placed on its website or application. The tag is associated with the created multiple advertisement placements and the parameters thereof. In one example, the tag may be in the form of a URL that can be copied by the publisher 604 and put onto one or more pages of its website. In another example, the tag may be a script that runs on the publisher's 604 website or application. In the advertisement placement/tag database 806, smart tags created by different publishers 604 are stored and indexed with respect to their corresponding advertisement placements and configured parameters. Based on a single unique smart tag, advertisement placements and parameter created by the corresponding publisher 604 can be retrieved in response to an advertisement serving request.

In this embodiment, the advertisement selection module 804 includes a request handling unit 814, a user information monitoring unit 816, an advertisement placement information retrieving unit 818, an advertisement placement decision unit 820, an advertisement placement solicitation unit 822, an advertisement selection unit 824, and an advertisement information transmission unit 826. The request handling unit 814 is configured to receive a request for presenting an advertisement to a user 610 (an advertisement serving request). The request is received with information associated with advertisement placements, such as a tag placed on a website or application of the publisher 604. As described above, the tag may be provided to the publisher 604 by the advertisement placement setup module 802 and associated with a set of initial advertisement placements (candidate advertisement placements). Once the user 610 visits the website or opens the application where the tag is placed by the publisher 604, a network call is made by the browser or application from the user's device 610 to the request handling unit 814. In this embodiment, the request handling unit 814 identifies the tag URL and provides it to the advertisement placement information retrieving unit 818.

The advertisement placement information retrieving unit 818 in this embodiment is responsible for retrieving the initial set of advertisement placements (candidate advertisement placements) and their associated parameters from the advertisement placement/tag database 806 based on the identified tag URL. The retrieved advertisement placement-related information is fed into the advertisement placement decision unit 820. On the other hand, the user information monitoring unit 816 in this embodiment is configured to obtain information related to the user 610 to which advertisements are served. That is, the user information monitoring unit 816 may dynamically collect user-related information at runtime. The user-related information includes personal information, such as the location, demographics or online activities of the user 610. The user-related information may also include any information related to the user's network (e.g., network speed, bandwidth, service provider, etc.), information related the user' device (e.g., device type, brand, hardware specification, etc.), and information related the applications (e.g., browser type, version, software configuration, etc.). For instance, the user's current network speed and bandwidth may be dynamically tested and used for determining whether an advertisement placement related to rich media types of advertisements (e.g., video advertisements) should be executed or not. In one example, the lower the bandwidth available at that time, the less likely an advertisement placement reserved for video advertisements would be executed. It is understood that in addition to dynamically collecting user-related information, some information may be retrieved from a user information database 828 that is built offline and kept updating. In this embodiment, the user-related information collected by the user information monitoring unit 816 is also fed into the advertisement placement decision unit 820. It is understood that other information, such as advertiser-related information, may also be dynamically collected and fed into the advertisement placement decision unit 820 in some embodiments.

In this embodiment, the advertisement placement decision unit 820 is configured to determine at least one advertisement placement from the retrieved initial set of candidate advertisement placements based, at least in part, on the information related to the user. That is, not all the advertisement placements preset by the publisher 604 may be suitable in view of the dynamic situation at the time when the user 610 makes the advertisement serving request. The advertisement placement decision unit 820 may consider the dynamic situation, for example, by comparing the user-related information against at least some of the parameters for each candidate advertisement placement to determine the suitable advertisement placement(s) for execution. For example, the publisher 604 may specify that certain advertisement placements are targeted and individualized for certain user segments. If the user 610 is not within those user segments, then the advertisement placement decision unit 820 may take those advertisement placements out from consideration. In some embodiments, the decision may be made based on other information, such as information related to advertisers or information related to an advertisement placement. In one example, the publisher 604 may designate a preferred advertiser for an advertisement placement in the passback mode. If the advertiser becomes unavailable at the time when the advertisement serving request is received, then the advertisement placement decision unit 820 may take that advertisement placement out as well. In another example, the publisher 604 may have entered an agreement with an advertiser for a guaranteed advertisement placement. If the contractual obligation has already been met at the time when the advertisement serving request is received, then the corresponding advertisement placement may also be filtered out at that time.

In this embodiment, the advertisement placement decision unit 820 not only filters candidate advertisement placement(s) from the initial set, but also determines the order in which the advertisement placements to be satisfied (execution order). In this embodiment, priorities of the advertisement placements in the initial set are considered by the advertisement placement decision unit 820. That is, if the publisher 604 has specified the execution order for some or all of the candidate advertisement placements, then this initial order will be taken into consideration by the advertisement placement decision unit 820. In some embodiments, the advertisement placement decision unit 820 may adjust the initial order set by the publisher 604 in view of the dynamic situation, for example based on information related to the user 610 and/or the advertisers 606. For example, if the user 610 is not within the targeted user group of an advertisement placement, instead of completely taking out the advertisement placement, the advertisement placement decision unit 820 may change the priority of the advertisement placement so that it will be executed at a lower ranking. Once the advertisement placement(s) and their execution order are determined, the advertisement placement decision unit 820 sends such information to the advertisement placement solicitation unit 822.

In this embodiment, the advertisement placement solicitation unit 822 is configured to request advertisers 606 to provide a response with respect to the determined advertisement placement(s). For example, the advertisement placement solicitation unit 822 may send a first request to a first set of advertisers to provide a first response with respect to a first advertisement placement that is ranked the highest by the advertisement placement decision unit 820. If no favorable response to the first request is received from the first set of advertisers, the advertisement placement solicitation unit 822 then may send a second request to a second set of advertisers (may be the same or different from the first set of advertisers) to provide a second response with respect to a second advertisement placement (determined based on the execution order). The solicitation process is repeated until a favorable response (e.g., a winning bid in the RTB mode or an acceptance in the passback mode) is received with respect to one of the advertisement placements. Each set of advertisers in the solicitation process may be dynamically determined based on the information related to the advertisers 606 and the information related to the user 610. For example, if the user 610 is determined to be a minor, then any advertisers in the tobacco industry may be filtered out for the solicitation process. The details of advertisement placement solicitation process are described above with respect to FIG. 7.

In this embodiment, the advertisement selection unit 824 is configured to select an advertisement based on the response from the advertisers 606 with respect to the determined advertisement placement(s). If a positive response is received by the advertisement placement solicitation unit 822, then the advertisement placement solicitation unit 822 may pass the positive response to the advertisement selection unit 824. For example, if the positive response is a winning bid for an advertisement placement in the RTB mode, then the advertisement selection unit 824 in conjunction with the winning advertiser may select suitable advertisements to be placed onto each advertisement unit/space of the advertisement placement. The advertisement information transmission unit 826 may transmit information associated with the selected advertisement for a presentation to the user 610. For instance, the advertisement information transmission unit 826 may send link(s) to the selected advertisement(s) to the user's browser as a valid advertisement serving response so that the user's browser can retrieve and render the selected advertisement(s) at the advertisement units/spaces according to the advertisement placement.

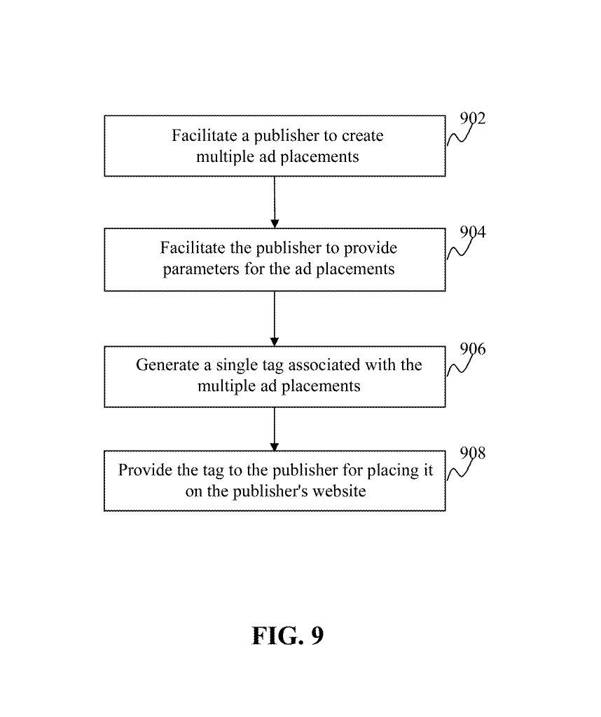

FIG. 9 is a flowchart of an exemplary process for facilitating publishers to set up multiple advertisement placements associated with a single tag, according to an embodiment of the present teaching. Starting at 902, a publisher is facilitated to create multiple advertisement placements. At 904, the publisher is also facilitated to provide parameters for the created advertisement placements. The parameters may be any criteria, conditions, limitations, or goals associated with each advertisement placement, such as operating modes, priorities, targeted user profiles, desired advertisers, and delivery requirement. At 906, a single tag associated with the multiple advertisement placements is generated. At 908, the tag is provided to the publisher in any suitable forms, such a URL that can be copied by the publisher and placed on its website or application. Some of the parameters related to users (e.g., targeted user profiles) may be checked against user-related information that is to be dynamically obtained upon receiving an advertisement serving request with the tag from a user when the user visits the publisher's website or application.

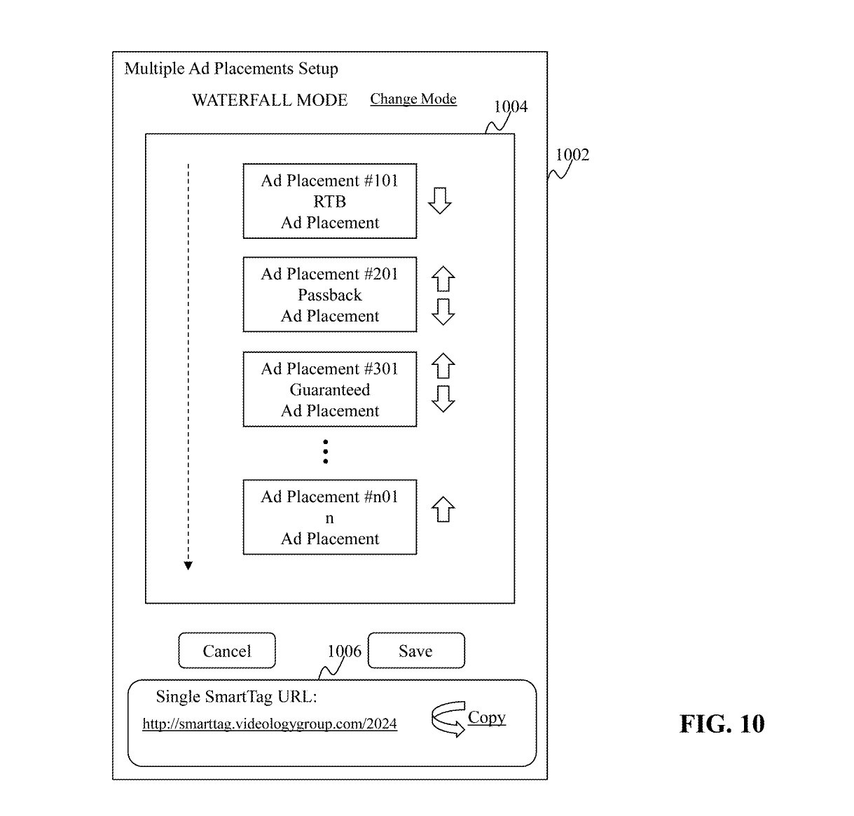

FIG. 10 illustrates one example of a user interface for multiple advertisement placements setup, according to an embodiment of the present teaching. The user interface 1002 is set up as waterfall mode 1004 in this embodiment. In the waterfall mode, a publisher, in addition to creating multiple advertisement placements (#101, #201, . . . , #n01), can set up the sequence of executing the advertisement placements. As shown in FIG. 10, an up/down button near each advertisement placement may be used to move up or down the corresponding advertisement placement in the sequence. As described above, the execution order of the advertisement placements keeps the SSP (e.g., the advertisement placement system 602) to continue soliciting responses from advertisers until the SSP receives a favorable response. This ensures that even with a single network call made to the SSP, the SSP can carry out the “waterfall” as set up by the publisher (the actual execution order may be adjusted at runtime in some embodiments), thereby maximizing the probability of receiving a favorable response and hence generating revenue from the single network call. The user interface 1002 also displays a single smart tag URL 1006 that is associated with the current advertisement placements set up in the waterfall mode 1004. The URL 1006 can be copied by the publisher and placed onto the publisher's website or application.

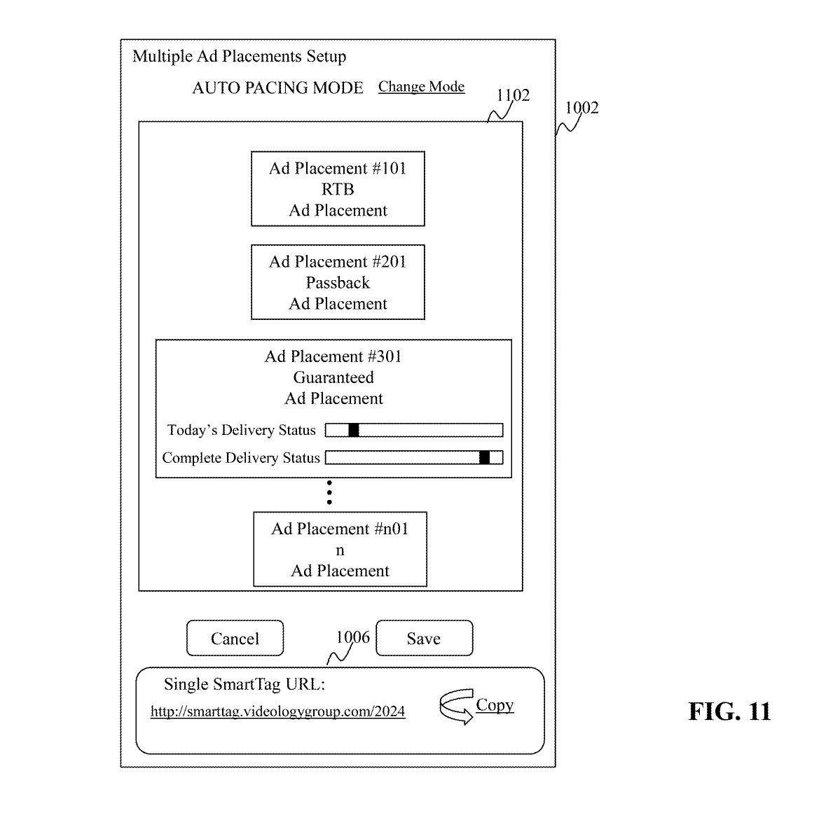

FIG. 11 illustrates another example of a user interface for multiple advertisement placements setup, according to an embodiment of the present teaching. Different from the waterfall mode 1004 in FIG. 10, the user interface 1002 in this embodiment is set up as auto pacing mode 1102. This mode is “automatic” in the sense that the publisher does not specify the execution order of the advertisement placements and completely relies on the SSP (e.g., the advertisement placement system 602) to make the dynamic decision at runtime. “Pacing” in this embodiment is reflected by the advertisement placement #301, which is set in the guaranteed mode. The guaranteed mode makes sure that an agreement that the publisher has entered with an advertiser will be honored. In operation, for example, the SSP may pick up the advertisement placement #301 and execute it enough times a day to meet the correct pace of delivery of advertisements to that advertiser. As shown in FIG. 11, a visual indication on how the advertisement placement #301 is pacing is provided on the user interface 1002 (“today's delivery status” and “complete delivery status”), which helps the publisher to monitor and manage the pacing.

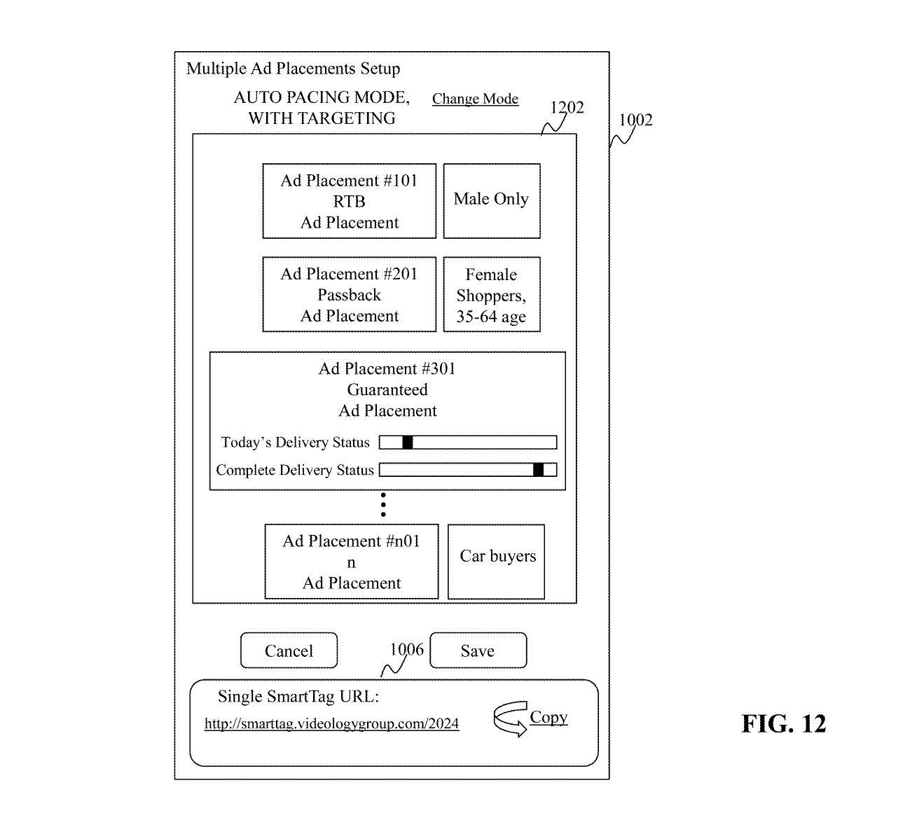

FIG. 12 illustrates still another example of a user interface for multiple advertisement placements setup, according to an embodiment of the present teaching. The user interface 1002 in this embodiment is set up as auto pacing mode with targeting 1202. In addition to auto pacing the advertisement placement #301, the publisher may make one or more advertisement placements targeted and individualized for a certain user group. For example, the advertisement placement #101 is targeted to male users only; the advertisement placement #201 is targeted to female shoppers who are 35-65 years old; and the advertisement placement #n01 is individualized for car buyers. The SSP (e.g., the advertisement placement system 602) then may make certain that only certain advertisers are solicited when certain users are detected. It is understood that the various modes mentioned in FIGS. 10-12 are not mutual exclusive to each other, but rather can be mixed-and-matched. For example, the publisher may set up the execution order for some or all of the advertisement placements in the auto pacing mode with targeting. In another example, the guaranteed advertisement placement #301 shown in FIG. 12 may be targeted and individualized for a certain user group as well.

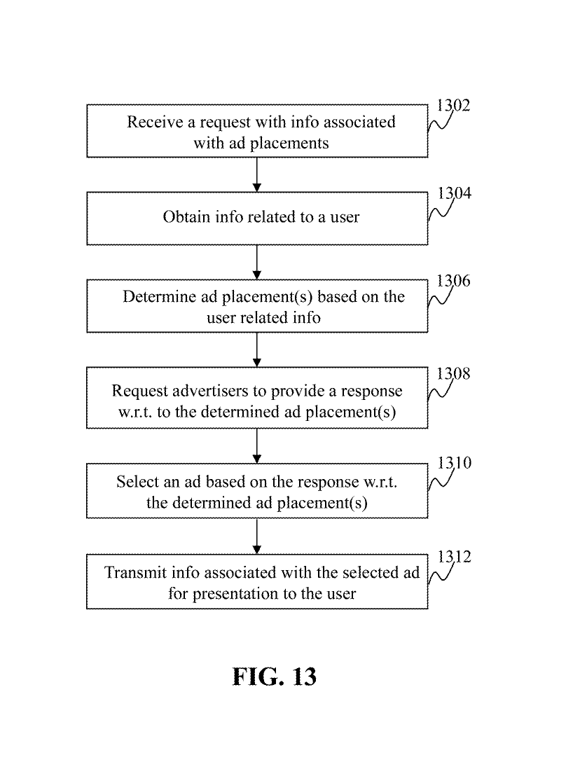

FIG. 13 is a flowchart of an exemplary process for selecting advertisement based on dynamic advertisement placement, according to an embodiment of the present teaching. Starting at 1302, an advertisement serving request with information associated with advertisement placements is received. The information associated with the advertisement placements may include a single smart tag. At 1304, information related to a user to whom advertisements are presented is obtained in response to the advertisement serving request. The information may include the user's personal information and information related to the user's network, device, or applications. At 1306, advertisement placement(s) are determined based on the user-related information and the information associated with advertisement placements, e.g., the single smart tag. The order of executing the advertisement placements may also be determined. At 1308, advertisers are requested to provide a response with respect to the determined advertisement placement(s). The request may be repeatedly made for each advertisement placement according to the execution order until a favorable response is received. At 1310, an advertisement is selected based on the 1e response with respect to the determined advertisement placement(s). At 1312, information associated with the selected advertisement is transmitted for presenting the advertisement to the user.

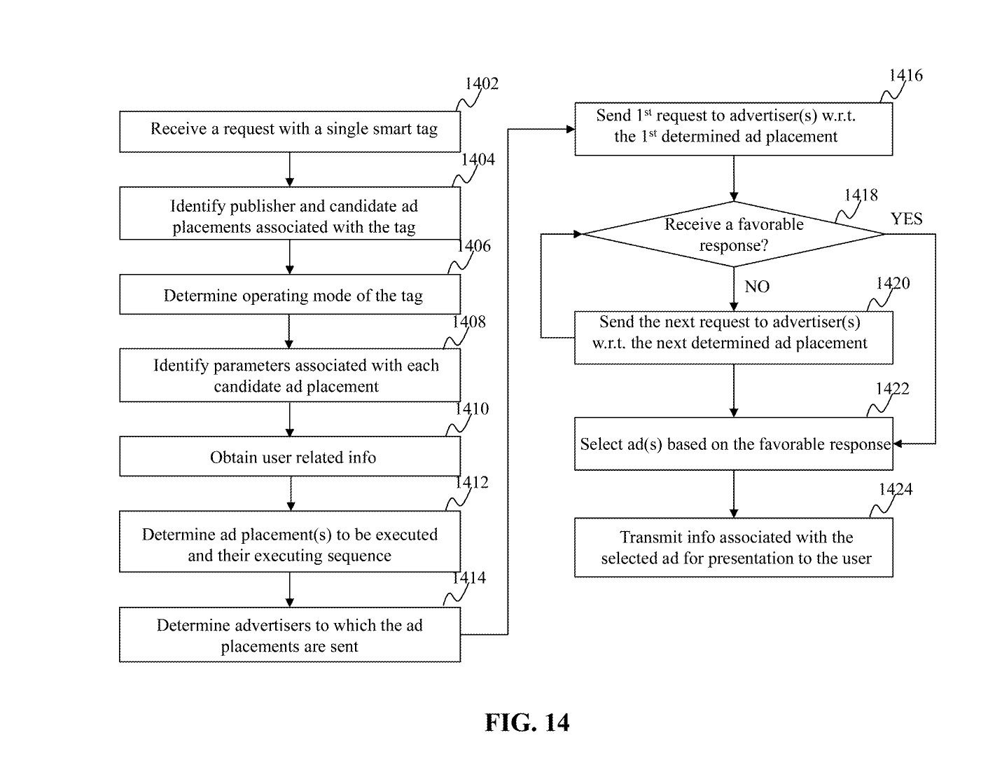

FIG. 14 is a flowchart of another exemplary process for selecting advertisement based on dynamic advertisement placement, according to an embodiment of the present teaching. Starting at 1402, an advertisement serving request with a single smart tag is received. At 1404, the publisher and the candidate advertisement placements associated with the tag are identified based on the tag. At 1406, the operating mode of the tag is determined. The operating mode of the tag includes, for example, waterfall mode, auto pacing mode, and auto pacing mode with targeting. At 1408, pre-configured parameters associated with each advertisement placement are identified based on the tag. At 1410, information related to the user to which the advertisement serving request is directed is obtained. At 1412, suitable advertisement placement(s) to be executed are selected from the candidate advertisement placements, and their execution sequence is determined as well. At 1414, advertisers to which the determined advertisement placement(s) are sent are determined. The determination may be made based on the information related to the advertisers and the information related to the user. At 1416, the first request is sent to the first set of advertisers for a response with respect to the first advertisement placement in the order. At 1418, whether a favorable response from the first set of advertisers is received is checked. If no favorable response is received, then at 1420 the next request is sent to the next set of advertisers for a response with respect to the next advertisement placement in the order. The processes of 1418 and 1420 are repeated until a favorable response is received. At 1422, one or more advertisements are selected based on the favorable response. At 1424, information associated with the selected advertisement(s) is transmitted for presenting the advertisement(s) to the user.

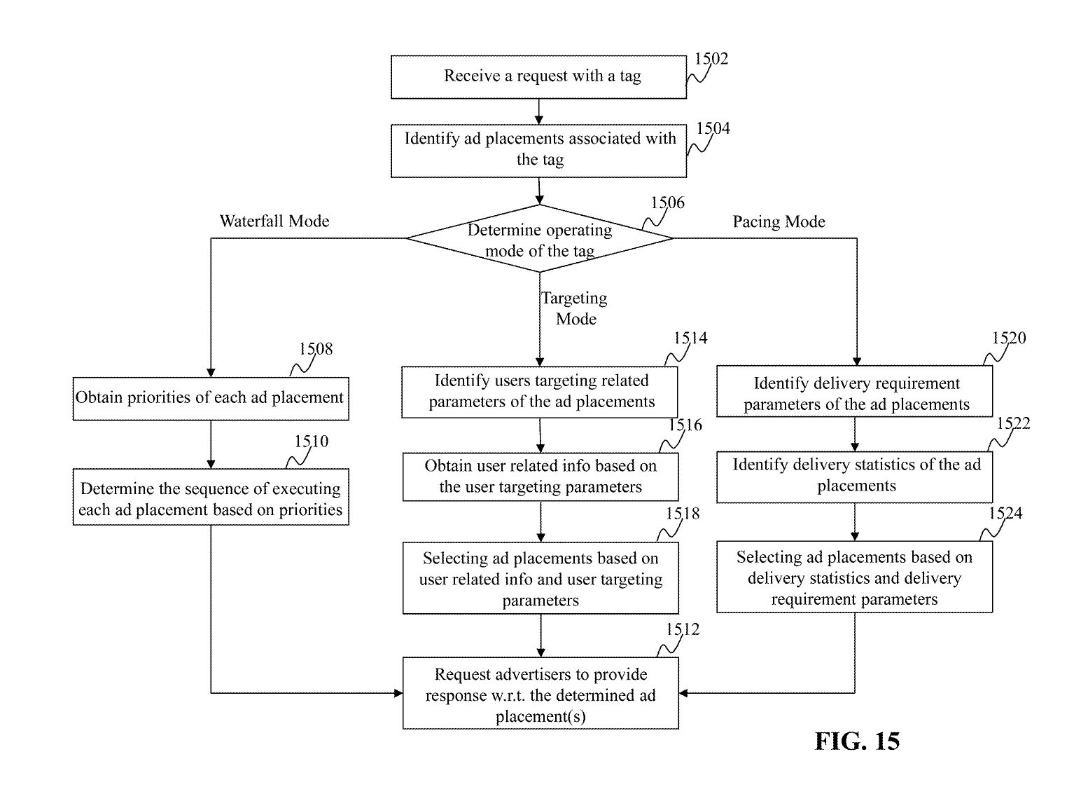

FIG. 15 is a flowchart of exemplary processes for dynamically determining advertisement placement in various operation modes, according to various embodiments of the present teaching. Starting at 1502, an advertisement serving request with a single smart tag is received. At 1504, advertisement placements associated with the tag are identified. At 1506, the operating mode associated with the tag is determined as either the waterfall mode, the targeting mode, or the pacing mode. If the operating mode is waterfall mode, the process continues to 1508, where priorities of each advertisement placement are obtained based on the tag. Priority is one type of the parameters pre-configured by the publisher via a use interface for example as shown in FIG. 10. At 1510, the sequence of executing each advertisement placement is determined based on the priorities. It is understood that the initial execution sequence may be adjusted at runtime based on dynamic situation as described above. At 1512, advertisers are requested to provide a response with respect to the determined advertisement placements. Back to 1506, if the operating mode of the tag is the targeting mode, then at 1514, parameters of the advertisement placements that are related to user targeting are identified. At 1516, user-related information is obtained based on the user targeting parameter. At 1518, advertisement placement(s) are selected from the initial candidate set based on the user-related information and the user targeting parameters. For example, the user's personal profile may be checked against the targeted user group of each advertisement placement to determine whether the user fits into any targeted user group. At 1512, advertisers are requested to provide a response with respect to the determined advertisement placements. Back to 1506 again, if the operating mode of the tag is determined to be the pacing mode, then at 1520, delivery requirement parameters of the advertisement placements are identified. At 1522, delivery statistics of the advertisement placements are identified. For example, the progress of completing a guaranteed deal is checked and may be used to determine whether the corresponding advertisement placement shall be assigned with a high priority in order to honor the deal in time. At 1524, advertisement placement(s) are selected from the initial candidate set and their execution sequence is determined based on the delivery statistics and the delivery requirement parameters. At 1512, advertisers are requested to provide a response with respect to the determined advertisement placements.

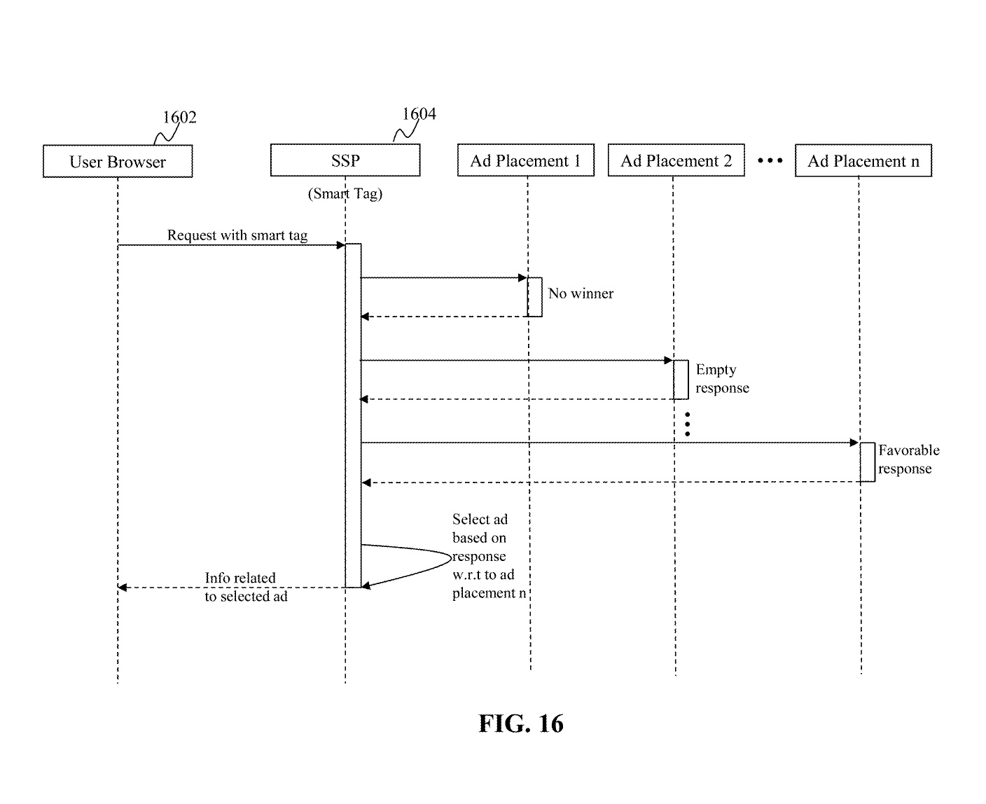

FIG. 16 is a time-line chart of an exemplary dynamic advertisement placement execution process, according to an embodiment of the present teaching. In this embodiment, a user browser 1602 activates a smart tag when it visits a publisher's website. The user browser then sends an advertisement serving request to an SSP 1604 directed by the smart tag. The SSP 1604 may be the advertisement placement system 602. Based on the smart tag and dynamic situation, such as user user-related information, the SSP 1604 determines at runtime the suitable advertisement placements to be executed and their execution order (advertisement placement 1, 2, . . . n). The SSP 1604 then executes first advertisement placement 1, which is in the RTB mode. It turns out that no winning advertiser is found in response to advertisement placement 1. The SSP 1604 then automatically executes the second advertisement placement 2 without the need to receive another request from the user browser 1602. In this example, there is no response received with respect to advertisement placement 2 either. The SSP 1604 then continues to execute other advertisement placements in the execution order until it receives a favorable response with respect to advertisement placement n. The SSP 1604 then selects advertisement(s) based on the favorable response and transmits information related to the selected advertisement(s) to the user browser 1602 as a response to the advertisement serving request.

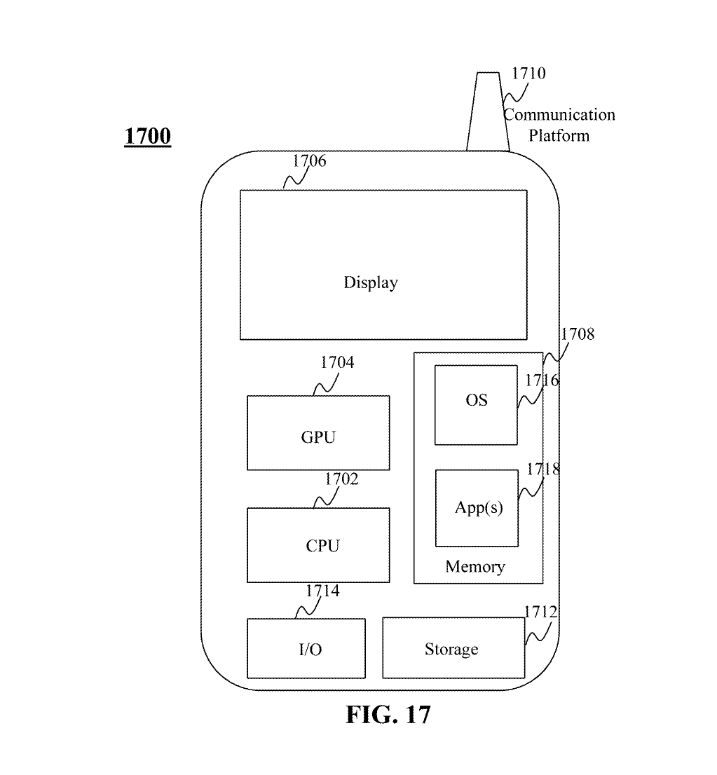

FIG. 17 depicts the architecture of a mobile device which can be used to realize a specialized system implementing the present teaching. In this example, the user device on which advertisements are presented and interacted with is a mobile device 1700, including but is not limited to, a smart phone, a tablet, a music player, a handheld gaming console, a global positioning system (GPS) receiver, and a wearable computing device (e.g., eyeglasses, wrist watch, etc.), or in any other form. The mobile device 1700 in this example includes one or more central processing units (CPUs) 1702, one or more graphic processing units (GPUs) 1704, a display 1706, a memory 1708, a communication platform 1710, such as a wireless communication module, storage 1712, and one or more input/output (I/O) devices 1714. Any other suitable component, such as but not limited to a system bus or a controller (not shown), may also be included in the mobile device 1700. As shown in FIG. 17, a mobile operating system 1716, e.g., iOS, Android, Windows Phone, etc., and one or more applications 1718 may be loaded into the memory 1708 from the storage 1712 in order to be executed by the CPU 1702. The applications 1718 may include a browser or any other suitable mobile apps for receiving and rendering content, such as advertisements, on the mobile device 1700. Execution of the applications 1718 may cause the mobile device 1700 to perform the processes as described above in the present teaching. For instance, the display of advertisements to users may be made by the GPU 1704 in conjunction with the display 1706. User interactions with the advertisements may be achieved via the I/O devices 1714 and provided to the system via the communication platform 1710.

To implement various modules, units, and their functionalities described in the present disclosure, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the dynamic advertisement placement method and system as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

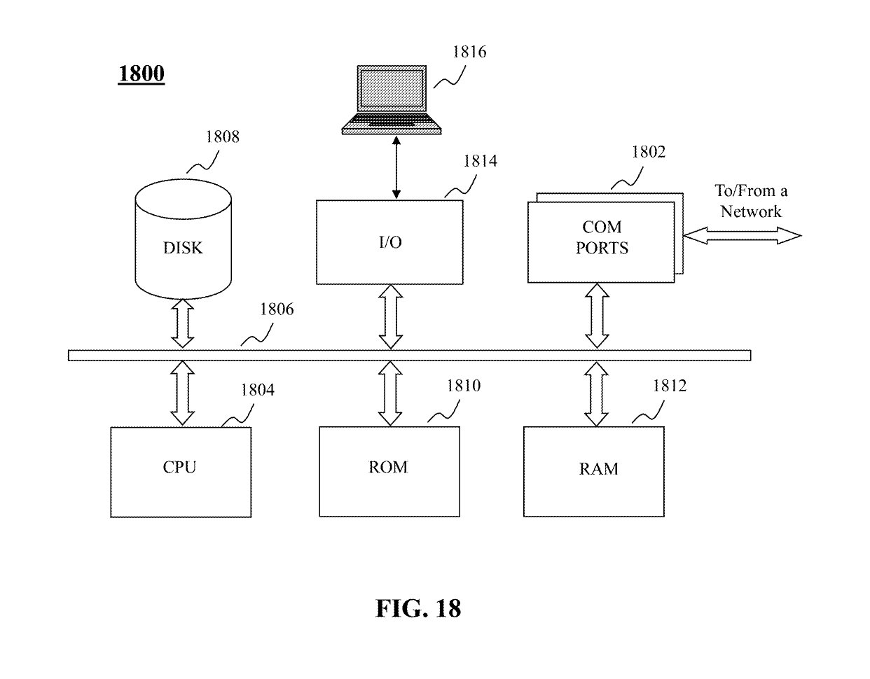

FIG. 18 depicts the architecture of a computing device which can be used to realize a specialized system implementing the present teaching. Such a specialized system incorporating the present teaching has a functional block diagram illustration of a hardware platform which includes user interface elements. The computer may be a general-purpose computer or a special purpose computer. Both can be used to implement a specialized system for the present teaching. This computer 1800 can be used to implement any components of the dynamic advertisement placement techniques, as described herein. For example, the advertisement placement system 602, etc., may be implemented on a computer such as computer 1800, via its hardware, software program, firmware, or a combination thereof. Although only one such computer is shown, for convenience, the computer functions relating to dynamic advertisement placement as described herein may be implemented in a distributed fashion on a number of similar platforms, to distribute the processing load.

The computer 1800, for example, includes COM ports 1802 connected to and from a network connected thereto to facilitate data communications. The computer 1800 also includes a central processing unit (CPU) 1804, in the form of one or more processors, for executing program instructions. The exemplary computer platform includes an internal communication bus 1806, program storage and data storage of different forms, e.g., disk 1808, read only memory (ROM) 1810, or random access memory (RAM) 1812, for various data files to be processed and/or communicated by the computer, as well as possibly program instructions to be executed by the CPU 1804. The computer 1800 also includes an I/O component 1814, supporting input/output flows between the computer and other components therein such as user interface elements 1816. The computer 1800 may also receive programming and data via network communications.

Hence, aspects of the method of online advertising based on dynamic advertisement placement, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator or other advertisement placement server into the hardware platform(s) of a computing environment or other system implementing a computing environment or similar functionalities in connection with dynamic advertisement placement. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teaching is amenable to a variety of modifications and/or enhancements. For example, although the implementation of various components described above may be embodied in a hardware device, it can also be implemented as a software only solution—e.g., an installation on an existing server. In addition, the dynamic advertisement placement as disclosed herein can be implemented as a firmware, firmware/software combination, firmware/hardware combination, or a hardware/firmware/software combination.

While the foregoing has described what are considered to constitute the present teaching and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teaching.

We claim:

1. A method, implemented on at least one computing device each of which has at least one processor, storage, and a communication platform connected to a network for providing an advertisement, the method comprising:
receiving a request for an advertisement to be presented to a user, wherein the request is received with information associated with a plurality of advertisement placements;
obtaining information related to the user;
selecting, from the plurality of advertisement placements, at least one advertisement placement based, at least in part, on the information related to the user;
requesting each of one or more parties to provide a response with respect to the selected at least one advertisement placement, wherein at least one response is associated with an advertisement to be presented to the user; and
transmitting information associated with the advertisement in response to the request.

2. The method of claim 1, wherein the information associated with the plurality of advertisement placements is provided by a publisher for placing one or more advertisements on a website or an application.

3. The method of claim 2, wherein the information associated with the plurality of advertisement placements comprises a tag placed on the website or the application.

4. The method of claim 2, wherein the information associated with the plurality of advertisement placements comprises one or more parameters for each of the plurality of advertisement placements.

5. The method of claim 3, wherein the one or more parameters for a corresponding advertisement placement comprise at least one of:
priority of the corresponding advertisement placement;
targeted user profile of the corresponding advertisement placement;
desired advertiser of the corresponding advertisement placement; and
delivery requirement of the corresponding advertisement placement.

6. The method of claim 4, wherein the at least one advertisement placement is selected based, at least in part, on the parameters for each of the plurality of advertisement placements.

7. The method of claim 4, wherein the at least one advertisement placement is selected by comparing the information related to the user against at least some of the parameters for each of the plurality of advertisement placements.

8. The method of claim 1, wherein the information related to the user comprises at least one of:
information related to the location of the user;
information related to the user's demographics;
information related to the user's online activities;
information related to the user's network;
information related to the user's device; and
information related to the user's application used for viewing the advertisement.

9. The method of claim 1, wherein the step of requesting each of one or more parties to provide a response comprises:
sending a first request to each of the one or more parties to provide a first response with respect to a first advertisement placement; and
if no response to the first request is received from any of the one or more parties, sending a second request to each of at least some of the one or more parties to provide a second response with respect to a second advertisement placement.

10. The method of claim 1, wherein the one or more parties comprise one or more advertisers determined based, at least in part, on the information related to the user.

11. A method, implemented on at least one computing device each of which has at least one processor, storage, and a communication platform connected to a network for providing content to a user, the method comprising:
receiving a first request from a user for content;
obtaining first information indicative of at least one advertisement unit to be provided with the content;
sending a second request for second information related to at least one advertisement to be presented to the user on the at least one advertisement unit, wherein
the request is sent with third information associated with a plurality of advertisement placements with respect to the at least one advertisement unit,
at least one advertisement placement is selected from the plurality of advertisement placements based, at least in part, on fourth information related to the user,
each of one or more parties is requested to provide a response with respect to the selected at least one advertisement placement, and
at least one response is associated with the at least one advertisement to be presented to the user; and
receiving the second information identified in response to the request; and
providing the content with the at least one advertisement to the user.

12. A method, implemented on at least one computing device each of which has at least one processor, storage, and a communication platform connected to a network for providing a tag for multiple advertisement placements, the method comprising:
facilitating a party to create a plurality of advertisement placements with respect to a website or an application;
facilitating the party to provide one or more parameters for each of the plurality of advertisement placements; and
providing, to the party, a tag to be placed on the website or the application, wherein the tag is associated with the plurality of advertisement placements, and
at least one of the one or more parameters is associated with information related to a user that is to be dynamically obtained upon receiving a request including the tag for an advertisement to be presented to the user on the website or the application.

13. The method of claim 12, wherein the information related to the user comprises at least one of:
information related to the location of the user;
information related to the user's demographics;
information related to the user's online activities;
information related to the user's network;
information related to the user's device; and
information related to the user's application used for browsing the website.

14. The method of claim 12, wherein priorities are provided by the party for each of the plurality of advertisement placements.

15. The method of claim 12, further comprising:
receiving the request for an advertisement to be presented to the user;
obtaining the information related to the user;
selecting, from the plurality of advertisement placements, at least one advertisement placement based, at least in part, on the information related to the user;
requesting each of one or more additional parties to provide a response with respect to the at least one advertisement placement, wherein at least one response is associated with an advertisement to be presented a user; and
transmitting information associated with the advertisement in response to the request.

16. The method of claim 15, wherein the at least one advertisement placement is selected by comparing the information related to the user against the parameter for each of the plurality of advertisement placements.

17. The method of claim 15, wherein the step of requesting each of one or more additional parties to provide a response comprises:
sending a first request to each of the one or more additional parties to provide a first response with respect to a first advertisement placement; and
if no response to the first request is received from any of the one or more additional parties, sending a second request to each of at least some of the one or more p additional arties to provide a second response with respect to a second advertisement placement.

18. The method of claim 12, wherein the party comprises a publisher, and the one or more additional parties comprise one or more advertisers.

19. A system having at least one processor storage, and a communication platform for providing an advertisement, the system comprising:
a request handling unit configured to receive a request for an advertisement to be presented to a user, wherein the request is received with information associated with a plurality of advertisement placements;
an information monitoring unit configured to obtain information related to the user;
an advertisement placement decision unit configured to select, from the plurality of advertisement placements, at least one advertisement placement based, at least in part, on the information related to the user;
an advertisement placement solicitation unit configured to request one or more parties to provide a response with respect to the at least one advertisement placement, wherein the response is associated with an advertisement to be presented to the user; and
a transmission unit configured to transmit information associated with the advertisement in response to the request.

20. The system of claim 19, wherein the information associated with the plurality of advertisement placements is provided by a publisher for placing advertisements on a website or an application.

21. The system of claim 20, wherein the information associated with the plurality of advertisement placements comprises a tag placed on the website or the application.

22. The system of claim 20, wherein the information associated with the plurality of advertisement placements comprises one or more parameters for each of the plurality of advertisement placements.

23. The system of claim 22, wherein the one or more parameters for a corresponding advertisement placement comprise at least one of:
priority of the corresponding advertisement placement;
targeted user profile of the corresponding advertisement placement;
desired advertiser of the corresponding advertisement placement; and
delivery requirement of the corresponding advertisement placement.

24. The system of claim 22, wherein the at least one advertisement placement is selected based, at least in part, on the parameters for each of the plurality of advertisement placements.

25. The system of claim 22, wherein the at least one advertisement placement is selected by comparing the information related to the user against at least some of the parameters for each of the plurality of advertisement placements.

26. The system of claim 19, wherein the information related to the user comprises at least one of:
information related to the location of the user;
information related to the user's demographics;
information related to the user's online activities;
information related to the user's network;
information related to the user's device; and
information related to the user's application used for browsing the website.

27. The system of claim 19, wherein the advertisement placement solicitation unit is configured to:
send a first request to the one or more parties to provide a first response with respect to a first advertisement placement; and
if no response to the first request is received from the one or more parties, send a second request to the one or more parties to provide a second response with respect to a second advertisement placement.

28. The system of claim 19, wherein the one or more parties comprise one or more advertisers determined based, at least in part, on the information related to the user.

29. A system having at least one processor storage, and a communication platform for providing a tag for multiple advertisement placements, the system comprising:
an advertisement placement creation unit configured to facilitate a party to create a plurality of advertisement placements with respect to a website or an application;
an advertisement placement configuration unit configured to facilitate the party to provide one or more parameters for each of the plurality of advertisement placements; and
a tag building unit configured to provide, to the party, a tag to be placed on the website or the application, wherein
the tag is associated with the plurality of advertisement placements, and
at least one of the one or more parameters is associated with information related to a user that is to be dynamically obtained upon receiving a request including the tag for an advertisement to be presented to the user on the website or the application.

30. The system of claim 29, wherein the information related to the user comprises at least one of:
information related to the location of the user;
information related to the user's demographics;
information related to the user's online activities;
information related to the user's network;
information related to the user's device; and
information related to the user's application used for browsing the website.

31. The system of claim 29, wherein priorities are provided by the party for each of the plurality of advertisement placements.
